(19) United States
(12) Patent Application Publication
(10) Pub. No.: US 2026/0259052 A1
(43) Pub. Date: Sep. 3, 2026

(54) TACTICAL PORTABLE COMMUNICATION SYSTEM FOR A USER AND TACTICAL INFORMATION SYSTEM

(71) Applicant: SYANS, ANGOULEME (FR)

(72) Inventor: Jerome SOUVERAIN, ANGOULÊME (FR)

(21) Appl. No.: 18/871,332

(22) PCT Filed: Jun. 8, 2022
(86) PCT No.: PCT/EP2022/065512

§ 371 Date: Dec. 3, 2024

(51) Int. Cl. G01C 21/00; H04L 67/125; H04W 4/024; H04W 4/80

(52) U.S. Cl. CPC G01C 21/005; H04L 67/125; H04W 4/024; H04W 4/80

(57) ABSTRACT

A tactical portable communication system, comprising a communication device provided with a casing that has arranged in it a processor, a communication module for communication with a wireless mesh network and a plurality of position and/or motion sensors for sensing a position and/or motion of a user, and a portable device able to be attached to a limb of the user and equipped with tactile stimulation members and with a control unit able to command and control each of the tactile stimulation members, where the communication device and the portable device each comprise associated wireless connection means, and in that the processor of the communication device is designed: on the basis of data received, by the communication module, from the mesh network and/or of measurements acquired by one or more of said sensors, to transmit an instruction to the control unit to control the tactile stimulation members.

The invention concerns the field of tactical communication, in particular for a soldier in a military operation, a security guard on a public or private security mission, an athlete in a sporting activity, or a firefighter on a rescue mission.

There are a number of different solutions that enable a user to receive tactical information, such as guidance in an unfamiliar environment to follow a pre-determined route or trail. These solutions generally employ a portable device, such as a smartphone, equipped with a satellite positioning system and a visual and/or voice interface for relaying navigation instructions to the user. Instructions are thus transmitted from a remote station and retransmitted, via a telecommunications network, to the user, via the portable device, so that the user can orient their position and follow a trail. Symmetrically, positioning data can be transmitted from the portable device to the remote station, via the telecommunications network, so that the user's position can be tracked remotely and instructions corrected according to this position with regard to the trail to be followed, before being transmitted to the portable device.

These solutions have a number of drawbacks that make them unsuitable for specific uses, such as military operations, operations requiring security personnel, rescue missions, or racing in isolated environments.

Indeed, solutions based on visual instructions require the user to regularly shift their attention to the portable device in order to take note of an instruction. The result is a loss of attention and concentration on the part of the user, which can be particularly damaging and dangerous in the context of a military operation, a rescue or security mission, or a race in a rugged environment.

Similarly, solutions based on voice instructions generate a disturbance for the user, who must concentrate on the surrounding sound environment. These voice instructions can also betray their position.

Finally, these solutions need to be connected to a telecommunications network to enable data exchange between the remote station and the portable device. However, in the cases mentioned, such a telecommunications network may not be always accessible, and the user may momentarily, or for longer periods, go beyond cellular coverage. In this case, the portable device no longer receives navigation instructions and no longer exchanges positioning data with the remote station, which can lead to service disruption and serious consequences for the user.

Solutions have been devised to overcome some of these drawbacks. This is the case, for example, with navigation assistance devices based on tactile stimulation, for example via vibrations generated on equipment worn by the user. These vibrations can be used to form a dictionary of navigation and/or action instructions, which can be intuitively understood by the user without disturbing their other senses. However, these solutions do not address the problem of service disruption due to insufficient network coverage.

In this context, the present invention aims to provide a portable tactical communication system for a user that alleviates the various disadvantages mentioned.

For these purposes, the invention relates to a portable tactical communication system for a user, comprising:
a. a communication device provided with a casing that has arranged in it a processor, a communication module for communication with a wireless mesh network, and a plurality of user position and/or motion sensors, and
b. a portable device able to be attached to a limb of a user and equipped with tactile stimulation members for the tactile stimulation of said limb and with a control unit able to command and control each of the tactile stimulation members, characterized in that the communication device and the portable device each comprise associated wireless connection means, and in that the processor of the communication device is designed:
c. on the basis of data received, by the communication module, from the mesh network and/or of measurements acquired by one or more of said sensors, to transmit, via the connection means, an instruction to the control unit of the portable device to control the tactile stimulation members;
d. on the basis of data received, by the communication module, from the mesh network and/or of measurements acquired by one or more of said sensors, to transmit, via the communication module, a sequence of data on the mesh network.

The invention thus proposes to combine the advantages of tactical communication solutions based on tactile stimulation of the user with the benefits conferred by a mesh network. The invention thus takes advantage of the fact that military operations, security operations, rescue operations or extreme sports generally require a team of multiple users, who can then each be equipped with a portable system according to the invention. In this way, the various communication devices of all these users' portable systems can form a wireless mesh network, which makes it possible, once one of the communication devices is connected to a communication network, to route data to another of these communication devices even when that device is outside network coverage, or even to be able to transmit data solely using the mesh network, without the support of communication infrastructure. According to the invention, the processor is advantageously arranged to generate a user movement instruction from data received from the mesh network and/or measurements acquired by one or more of the sensors, and to generate an instruction from said instruction, which is transmitted to the control unit of the portable device. The team can move autonomously and synchronously, with the positions and movements of each user known to the others. Last but not least, all the components needed for the service are integrated into a single casing, so users are not overburdened with separate pieces of equipment.

In the present invention, “processor” means one or more electronic components, in particular a single circuit or a plurality of integrated circuits, mounted on a single printed circuit board or on a plurality of separate printed circuit boards. The electronic component(s) are, together or separately, capable of executing arithmetic, logic, data reading and writing instructions in a memory, in particular to execute one or more computer programs to implement one or more functions required for the operation of the communication device.

In the present invention, “tactile stimulation” means a stimulus exerted on the skin of the limb of the user by a stimulation member, the stimulus being a vibration, an electrical pulse, or a force. Each tactile stimulator may, for example, comprise a piezoelectric element or an electrode.

In the present invention, “wearable device” means equipment that can be attached to a user's limb, such as the hand, wrist or forearm, and arranged so that, once attached, the tactile stimulation members are able to cause the skin of said limb to be stimulated, for example by being in contact with this skin. For example, the wearable device may comprise a support, such as a bracelet, glove, or sleeve, designed to be attached to the user's wrist or hand, and made of a flexible material, such as silicone and/or a textile. If required, the support may comprise a central portion at which the control unit is arranged, with the stimulation members arranged in a star shape around the control unit.

In the present invention, “wireless mesh network” means a network of communication devices wherein each communication device is a node, wherein each node is connected to multiple nodes, or as many nodes as possible, and wherein each node acts as both sender and receiver and cooperates with the nodes to which it is connected to transmit data from the sender to the recipient. For example, data can be routed by bouncing from node to node along a predefined path until it reaches its destination. Alternatively, a message can be relayed by “flooding”, with each node attempting to transmit each message to each of its neighbors (which may or may not include the source node). In this way, each message is ultimately transmitted to all reachable parts of the network.

A data sequence may contain a “time to live” or a bounce counter, and each node may be arranged to decrement the time to live or counter of a sequence it receives, and to destroy a sequence without relaying it when its time to live or counter reaches a given threshold. Alternatively, each data sequence can contain a code, and each node can be arranged to relay a sequence it receives only if its code is unknown. Also alternatively, each node may be able to classify itself into a first or second configuration by identifying echoes of a data sequence it had transmitted and which was then sent back to it by another node, its ability to retransmit or not transmit a data sequence it receives depending on the configuration into which it has classified itself. Reference may be made, for example, to U.S. Pat. No. 10,944,669, which describes such an example of a protocol for retransmission of a data sequence by a node in a mesh network.

In the present invention, “communication module” means a module comprising at least one antenna and a set of electronic components forming a receiving chain capable of filtering, amplifying, and demodulating, in analog and/or digital form, a signal from an electromagnetic wave picked up by the antenna to obtain a modulating signal carried by said electromagnetic wave, which can form, directly or indirectly, a data sequence and a transmission chain able to modulate a carrier with a modulating signal, formed directly or indirectly from a data sequence, and to amplify the modulated signal to be transmitted by the antenna in the form of an electromagnetic wave.

In the present invention, the “wireless connection means” may be “Bluetooth Low Energy” transceivers.

In one embodiment of the invention, upon receipt of a data sequence from the mesh network by the communication module, the communication module is able to retransmit the received data sequence onto the mesh network. The communication module is thus set up to rebroadcast a data sequence it receives to all available nodes in the mesh network to which it is connected.

In an exemplary embodiment of the invention, the communication device may be associated with a given identifier. If required, the communication module is arranged so that each data sequence it transmits on the mesh network contains the identifier of this communication device. Furthermore, it is arranged to detect an identifier of a communication device in a data sequence it receives, to compare the detected identifier with the identifier associated with it, and to retransmit said received data sequence on the mesh network in the event of a discrepancy between said detected and associated identifiers.

In one embodiment of the invention, the processor is arranged to identify an encryption key, in a data sequence received by the communication module, and to encrypt each data sequence to be transmitted by the communication module using the encryption key. According to this feature, an encryption key is thus generated by a central control device responsible for instantiating the mesh network and transmitted by this central control device, following initialization of the mesh network, to all the nodes of this mesh network so that they can encrypt their data using the same encryption algorithm, for example of the AES type, and the same encryption key.

Advantageously, the processor is arranged to estimate a movement of the user, from measurements acquired by one or more of said sensors, since their last known position and to estimate a new position of the user from said estimated movement and said last known position. In this embodiment, where the communication device comprises a satellite positioning system receiver, the system is thus able to maintain an estimate of the user's position when the receiver temporarily fails or suffers a temporary loss of connectivity. Preferably, the processor is arranged to transmit, via the communication module, a data sequence containing said new position on the mesh network.

For example, the processor may be arranged to determine a direction taken by the user since their last known position, and a number of steps or strides taken by the user since their last known position, and to estimate a distance covered by the user since their last known position from said number of steps or strides and said direction taken. Said new position is thus estimated from this estimated distance and the last known position. For example, said direction taken and the number of steps or strides can be determined by the processor from data acquired by an inertial unit or by a pedometer and compass, and possibly by comparing this acquired data with a model corresponding to one or more of the user's strides.

If desired, the processor can be arranged to estimate the user's speed of movement, for example from data acquired by an inertial unit and/or a change in the user's altitude since their last known position, for example from data acquired by an altimeter or barometer. If required, the processor can be arranged to estimate said distance covered from the number of steps or strides, the estimated speed and/or the estimated change in altitude.

Optionally, the communication device comprises a receiver of a satellite positioning system, whereby said last known position may be the last position determined by said receiver. If required, the processor can be arranged to correct the new estimated position to a position subsequently determined by the satellite positioning system receiver.

In one embodiment of the invention, the communication device is arranged to receive, from the mesh network, a sequence of data defining a trail between a start position and an end position, and the processor is arranged to determine, from said sequence of data, a set of waypoints fragmenting said trail and to transmit, via the connection means, an instruction to the control unit of the portable device for controlling the tactile stimulation members, said instruction being determined as a function of a user position estimated from measurements acquired by one or more of said sensors and said set of waypoints. The set of waypoints can advantageously be stored in a memory of the communication device.

For example, said trail may comprise a set of points between the start position and the end position, each associated with coordinates, and the processor may be arranged to select only those successive points which are separated by a distance greater than a threshold value and which form an angle (with another point) greater than a threshold value. The data sequence could, for example, be a file in GPX format. In this way, the processor minimizes the number of points on the trail, keeping only those waypoints that will induce a movement instruction for the user.

In an embodiment of the invention, the communication device comprises a memory wherein are stored a plurality of predetermined instructions for controlling the tactile stimulation members, the processor is arranged to select at least one of said predetermined instructions stored in said memory as a function of said user's estimated position with respect to at least one of the waypoints and to transmit, via the connection means, said selected instruction to the control unit of the portable device, and the control unit is arranged, in response to receiving said instruction, to control the tactile stimulation members to generate said selected instruction.

Advantageously, the processor can be arranged to estimate a distance and/or direction between the user's estimated position and the next waypoint, that is, the waypoint closest to said estimated position and located further down the trail from said estimated position. Alternatively or cumulatively, the processor can be arranged to estimate a drift between the user's estimated position and a trajectory between the last waypoint crossed by the user, that is, the waypoint closest to said estimated position and located upstream, with respect to the trail, of said estimated position, and the next waypoint.

For example, each stimulator can be activated, alone or in combination with one or more other stimulators, to notify the user of a movement, such as “forward”, “backward”, “45° left/right turn”, “90° left/right turn” or “stop”. For example, the position of the or each activated stimulator may correspond to a direction to be taken by the user. For example, multiple stimulation devices can be activated simultaneously or sequentially to generate a navigation notification, such as “start position”, “end position”, “alert before changing course”, “off course”. In this case, the sensor(s) activated, the order of their activation, the sequence of activation, the duration and/or intensity of activation, or even the number of times each sensor is activated, can thus form a predetermined control instruction associated with a desired travel or navigation notification.

According to a non-limiting example, it can be provided that:
a. when the distance between the user's estimated position and the next waypoint is less than a given threshold value, said threshold value possibly being set as a function of the user's estimated speed, the processor selects an instruction associated with a navigation notification of the “alert before changing course” type;
b. when the user's estimated position is at a waypoint, the processor determines the direction of the next waypoint and selects an instruction associated with a movement notification informing the user of said determined direction;
c. when the user's estimated position deviates from said determined direction, the processor selects an instruction associated with a navigation notification of the “off course” type, then determines the direction of the next waypoint and selects an instruction associated with a movement notification notifying the user of said determined direction;
d. when the user's estimated position is at the end position of the trail, the processor selects an instruction associated with a “stop” movement notification, then another instruction associated with an “end position” navigation notification.

Advantageously, the portable device can be equipped with one or more buttons with which the user can interact, and the control unit of the portable device can be arranged to transmit to the processor, via the connection means, data indicating that one or more buttons have been used. If required, the processor can be arranged to recognize, from said data, a button activation sequence from a plurality of predetermined sequences stored in a memory of the communication device and to transmit on the mesh network, via the communication module, a data sequence containing a message associated with said recognized button activation sequence. In this way, the portable device can transmit a pre-coded message on the mesh network, associated in advance with a given button activation sequence, such as an alert, without the user having to utter a sound. An activation sequence is defined as a single button press, a double or repeated button press, or a sequence of button presses.

Advantageously, the communication device comprises at least one sound sensor and the processor is arranged to determine whether a sound detected by said sound sensor is a gunshot sound, in particular other than that carried by the user, to estimate a direction of reception of said detected sound and to transmit, via the communication module, a data sequence containing said estimated direction of reception over the mesh network. Since the same sound can be detected by the sound sensors of several communication devices, it is possible to detect the position of origin of the shot. For example, the processor could be arranged to compare a detected sound intensity to a given threshold and/or to a sound pattern associated with a gunshot.

In one embodiment of the invention, the system comprises a device for detecting a shot fired by the user, this detection device comprising wireless connection means associated with the wireless connection means of the communication device, and the detection device and/or the processor of the communication device is arranged to estimate a number of shots fired by the user over a period of time, from measurements acquired by the detection device, the processor being arranged to transmit, via the communication module, a data sequence containing said estimated number over the mesh network. For example, the detection device could comprise an accelerometer and a sound sensor, the detection device being mounted on the user's firearm. If required, the detection device and/or processor can be arranged to detect a shot if the intensity of a sound detected by the sound sensor exceeds a given threshold value and if at least one acceleration detected by the accelerometer exceeds a given threshold value. According to this feature, it is possible to remotely monitor the amount of ammunition available to the user and estimate whether it is necessary to plan for a reload.

In one embodiment of the invention, the communication module is adapted to transmit a data sequence over the mesh network by modulating, using said data sequence, a carrier wave having a center frequency selected from a plurality of predetermined center frequencies, and the processor is arranged to periodically select a new center frequency from said plurality of predetermined center frequencies for said transmission. For example, the processor could be arranged to change the center frequency every 30 minutes. If required, the communication module may be able to receive, from the mesh network, a data sequence containing a clock synchronization instruction, and the processor may be arranged to update a clock signal from said synchronization instruction. Symmetrically, the communication module is able to filter a carrier wave received in a frequency band centered around said center frequency.

The invention also relates to a tactical information system, comprising a plurality of portable systems according to one of the preceding claims, and a central control device comprising a processor, a visualization and interaction interface and a communication module with a wireless mesh network, the communication devices of all the portable systems and the central device forming a wireless mesh network, each communication device being able to exchange data, via its communication module and through the wireless mesh network, with the central device.

It can be provided that either:
a. the central control device is a device of a portable system further comprising a portable device adapted to be attached to a limb of a user and equipped with tactile stimulation members for the tactile stimulation of said limb and a control unit adapted to command and control each of the tactile stimulation members, the central control device thus being intended for a team leader moving simultaneously with the rest of the users; or
b. the central control device is a station, e.g. a vehicle-mounted station.

In one embodiment of the invention, the central control device is arranged to, depending on a user's interaction with the visualization and interaction interface, transmit to the communication device of at least one of the portable systems, via its communication module and through the wireless mesh network, a data sequence defining a trail between a start position and an end position. The central device can transmit the said data sequence to a single portable system, to multiple portable systems or to all portable systems, or multiple distinct data sequences, each defining a distinct trail, can be transmitted to different portable systems.

Advantageously, the central device is able to receive, from the communication device of at least one of the portable systems, a data sequence containing a position of the user of this portable system, and the processor of the central device is arranged, upon receipt of said data sequence, to update a map displayed on the visualization and interaction interface using said user position. Said user position can be a position determined by a satellite positioning system receiver or estimated from measurements acquired by one or more of the sensors of this portable system. The central device thus enables the positions of the various users to be monitored.

Advantageously, the central device is able to receive, from the communication device of at least one of the portable systems, a data sequence containing a position of the user of this portable system, and the processor of the central device is arranged, upon receipt of said data sequence, to compare said position of the user with respect to a predetermined geographical area and, as a function of said comparison, to transmit, via the communication module and through the wireless mesh network, a data sequence containing an alert. Said predetermined geographical zone could, for example, be a security perimeter of a high-risk area, with the system warning users that they are approaching and/or crossing the said perimeter.

In one embodiment of the invention, the central device is adapted to receive, from the communication device of at least three of the portable systems, data sequences each containing a direction of reception of a same sound of a detected gunshot, and the processor of the central device is arranged, upon reception of said data sequences, to determine a position of origin of said shot. The processor of the central device may, for example, be arranged to check, on the basis of the transmitted positions of the users of these portable systems, that the portable systems are misaligned, and, if necessary, to triangulate said original position on the basis of said transmitted directions of reception.

The invention also relates to a communication device of a portable communication system according to the invention.

Advantageously, the casing of the communication device can be made, in whole or in part, from an aluminum-based material, in particular an anodized aluminum-magnesium alloy. If required, the enclosure may have an ingress protection rating, as defined in EN 60529, of IP 68 and/or a impact protection rating, as defined in EN 62262, of IK 6.

Preferably, the casing can be provided with grooves on one or more of these walls. In particular, these grooves dissipate the heat emitted by the various electronic components arranged in the casing.

Preferably, the communication device may comprise a battery, in particular comprising one or more lithium-titanate or lithium-ion accumulators, and possibly a conversion device capable of supplying electrical power to the various electronic components of the communication device from electrical power delivered by said battery. If required, the communication device may comprise a luminous indicator of the state of charge of said battery.

Advantageously, the casing may comprise two parts, in particular a lower part and an upper part, and the battery and, where applicable, the conversion device and the indicator light, is arranged in one of the parts, in particular the lower part, while the processor, the communication module and said plurality of sensors are arranged in the other of the parts, in particular the upper part. Preferably, the communication device may comprise an electrical connector arranged in the upper part of the casing, with a portion of the connector passing through an opening in a bottom wall of this upper part to extend into the lower part of the casing. If required, the lower and upper parts can be provided with complementary fastening members, such as snap-fit members, and can be arranged so that when the lower part is mounted on the upper part and the fastening members cooperate with each other, the electrical connector engages with an electrical connection member of the conversion device. If desired, the conversion device can be arranged to detect said cooperation and to automatically supply said power to the electronic components of the communication device in response to said detection.

Even more advantageously, the communication device may be devoid of an interface enabling the user to enter and/or view data, in particular data received by the communication module. In particular, the communication device may be devoid of a touch screen.

In one embodiment of the invention, the communication device may comprise a single button, for example of the push-button type. This button could, for example, control the switching of the communication device's processor between an active and an inactive configuration. Alternatively, or cumulatively, this button may be able to control the transmission of an alert by the communication module on the mesh network.

Advantageously, said button can be arranged on a wall of the casing, in particular a wall of the upper part of the casing, extending through an opening made in this wall. If required, said button can be fitted with a casing sealing element, such as a silicone layer. If desired, said button can be funnel-shaped, tapering towards the inside of the casing and centered on an electronic switching element arranged in the casing. If required, said button may have a plurality of pins distributed around its perimeter and fitting into holes in the casing wall. These pins prevent any movement of the button except towards the switching element, this direction favored by the funnel shape of the button. This ensures that even a poorly aimed button press will switch the switching element.

In one embodiment of the invention, the communication device comprises at least one sensor or a combination of sensors chosen from: an accelerometer, a gyroscope, an inertial unit, in particular 6-axis or 9-axis, a compass, a satellite positioning system receiver, in particular of the GPS or Galileo type, a barometer, an altimeter, a pedometer.

Advantageously, the communication device comprises at least one motion sensor, in particular a central inertial unit and a barometer, and at least one satellite positioning system receiver. If required, said motion sensor and receiver are arranged on the same printed circuit board.

Preferably, the communication device may comprise a cover made of a plastic polymer and interposed between said printed circuit board and the casing, the cover having a window facing said motion sensor(s) and a recess facing the receiver. If required, the casing has a window in a wall opposite which the cover is provided, and the recess in the cover protrudes from the window. The cover protects the various sensors, seals the casing, and enables the receiver to receive positioning data.

Advantageously, the communication device comprises a stack of printed circuit boards supporting the processor and all or part of the communication module, the stack of boards being arranged inside the casing. If necessary, the printed circuit board supporting the motion sensor(s) and the receiver extends perpendicularly to this stack of printed circuit boards, and the communication device comprises a plating part attached to the casing, in particular by screwing, and arranged to press one or more of these printed circuit boards, or even all these printed circuit boards, against the casing.

In one embodiment of the invention, the casing comprises a ring mounted at an opening in a wall, in particular a top wall, of the casing, with an antenna of the communication module extending through said aperture and the ring. Advantageously, the casing comprises an antenna protection cap mounted on the ring. Preferably, the cap has a side hole, formed on a peripheral wall of the cap, and a distal hole, opposite the ring. The side hole allows a wire antenna to pass through, while the distal hole allows a tube antenna to pass through, thus leaving the choice of antenna type for the communication module open. Even more preferably, the ring has a plurality of locating holes evenly distributed around its circumference and the cap has one or more locating pins evenly distributed around its circumference, the or each locating pin fitting into one of the locating holes. These holes and pins hold the cap in place on the ring, while allowing the user to choose the orientation of the cap, and in particular its side hole.

If desired, all or some of the electronic components arranged in the casing, particularly in the upper part of the casing, can be encapsulated with silicone or resin, particularly to dissipate heat emitted by these components and to absorb shocks and vibrations likely to damage these components.

Another object of the invention is a communication device with one or more of the above features.

The present invention is now described with the aid of examples that are purely illustrative and in no way limiting on the scope of the invention, and based on the attached drawings, in which the various figures show:

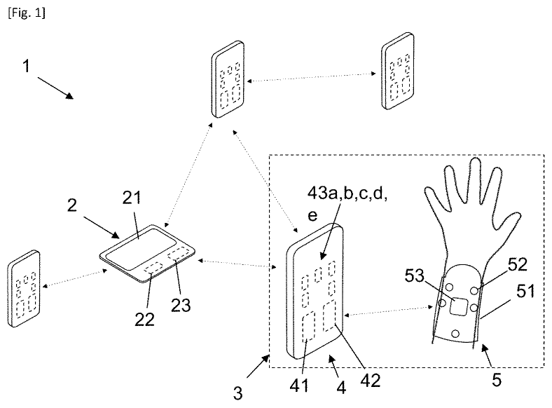

FIG. 1 schematically and partially shows a tactical information system, comprising a plurality of portable systems according to the invention;

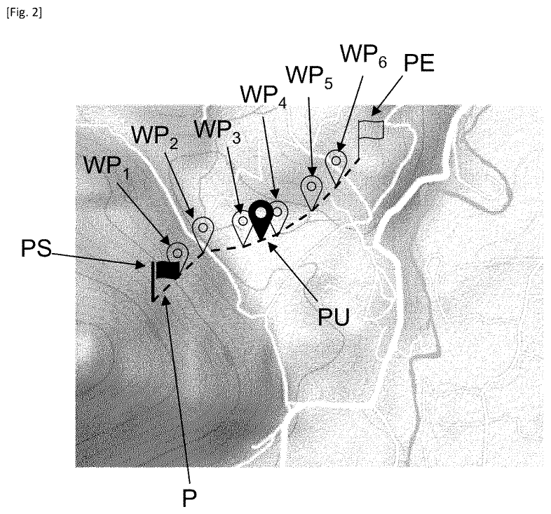

FIG. 2 schematically and partially shows an example movement of a user equipped with a portable system according to the invention;

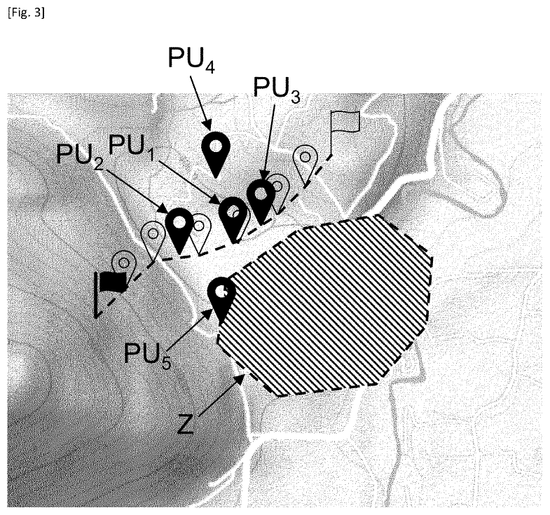

FIG. 3 schematically and partially shows an example movement of a group of users, each equipped with a portable system, the whole forming the tactical information system of FIG. 1;

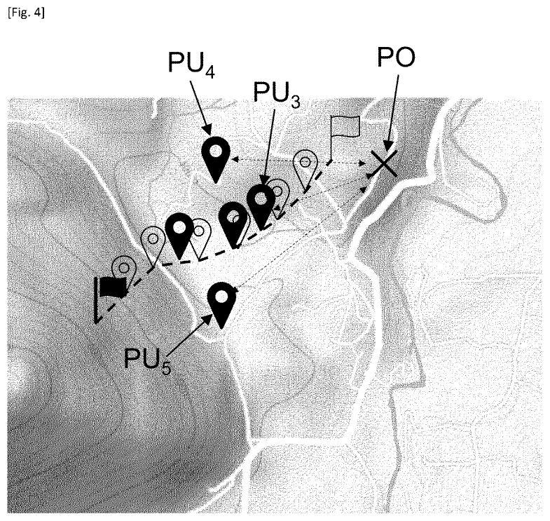

FIG. 4 schematically and partially shows an example of triangulation of the position of origin of a shot using the tactical information system shown in FIG. 1;

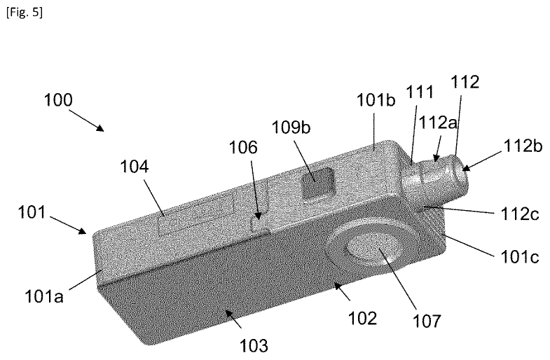

FIG. 5 schematically and partially shows an example communication device for a portable system according to the invention;

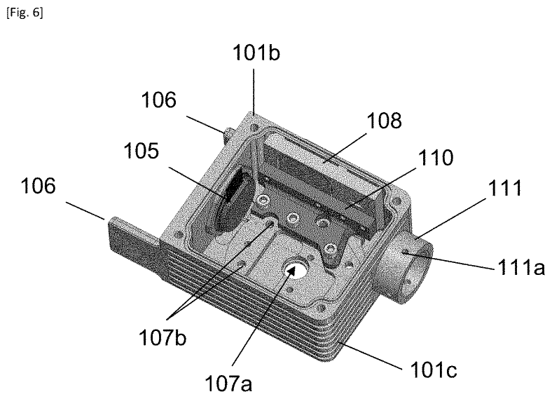

FIG. 6 schematically and partially shows a side view of the battery of FIG. 5 after assembly; and

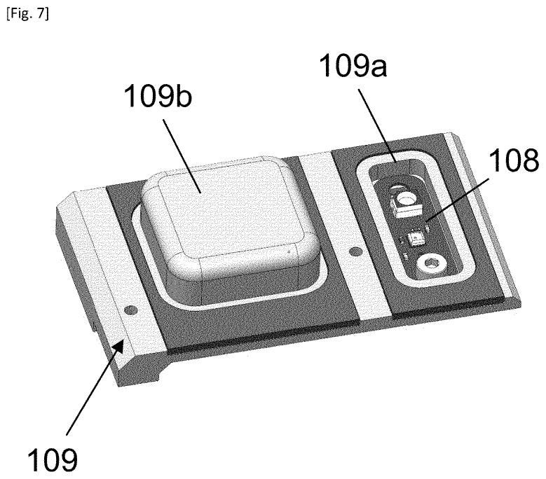

FIG. 7 schematically and partially shows a cover arranged in the casing of FIG. 6.

In the following description, identical elements, by structure or function, appearing in different figures retain, unless otherwise specified, the same references.

FIG. 1 describes a tactical information system 1 for a team of a plurality of users, comprising a central control device 2, intended for a team leader, and a plurality of portable tactical communication systems 3, each intended for one of the other team members.

In the example shown in FIG. 1, the central control device 2 is a smartphone equipped, among other things, with a processor 21, a wireless communication module 22 and a touch screen 23, with which a user can interact to control device 2 and exchange data with systems 3. The central device 2 can be arranged in forms other than a smartphone, and in particular in the form of a touch-sensitive tablet, a laptop, or a mobile computing station.

Each system 3 comprises a communication device 4 provided with a casing in which a processor 41, a wireless communication module 42, and a plurality of sensors are arranged. More specifically, each communication device 4 is equipped with a satellite positioning system receiver 43a, a barometer 43b, an inertial unit 43c, a compass 43d, and a sound sensor 43e. It may be possible to integrate the function of the compass 43d into a so-called 9-axis inertial unit.

Each system 3 also includes a wearable device 5 designed to be attached to a limb of the system user. In the example shown in FIG. 1, for the sake of brevity, only one of the portable devices 5 has been shown.

The wearable device 5 comprises a support 51, in the form of a sleeve made of a flexible material such as silicone, for attachment to the user's wrist. Vibrating members 52, for example formed by piezoelectric actuators, are arranged in the support 51 or at an inner surface of the support 51 so that their vibrations can be transmitted to the skin of the user's wrist.

In the example described, device 5 comprises five vibrating members 52, arranged so that two members 52 are disposed at a front, left, and right upper part of the wrist, two further members 52 are disposed at a side, left, and right part of the wrist, and one member 52 is disposed at a rear, central upper part of the wrist. The device 5 comprises a control unit 53 capable of selectively controlling each of the vibrating members 52, which are arranged in a star configuration around this control unit 53. A different number and/or arrangement of vibratory members 52 may be provided without departing from the scope of the present invention.

Each communication device 4 and its associated portable device 5 have associated wireless connection means, such as BLE or Bluetooth Low Energy transceivers, enabling the processor 41 to exchange data with the control unit 53.

In the example described, the central control device 2 further comprises all the sensors 43a to 43e and is also associated with a portable device 5 intended to equip the team leader, the processor 21 thus being able to exchange data with the control unit 53 of this portable device 5.

All the communication devices 4 and the central control device 2 form a wireless mesh network, which is either partial, as in the example shown in FIG. 1, or complete.

To this end, each of the communication modules 22 and 42 comprises a radio transceiver equipped with an antenna, these communication modules 22 and 42 thus forming nodes which are each connected to at least one other node of the mesh network, or more precisely to as many nodes of the mesh network as possible. In the case of the communication module 22, the antenna can be integrated therein, or alternatively, it may be an external antenna paired via a wireless connection or connected via a wired link to the rest of the 22 communication module.

In addition, each of the processors 21 and 41 is programmed to define how the communication modules 22 and 42 are to interact with the mesh network. For example, each of the processors 21 and 41 can be programmed to transmit data by flooding. In this configuration, each of the nodes is thus able to retransmit, or redistribute, a message or data sequence it receives to at least one, in particular multiple, or even all of the nodes in the mesh network to which it is connected.

In other words, when a message is transmitted from a source node to a destination node, this message is distributed by the source node to each of the nodes to which it is connected, then by each of these nodes to the nodes to which they themselves are connected, and so on until the message reaches the destination node.

The processors 21 and 41 may be programmed to add a bounce counter or time-to-live (TTL) to a message before distributing it for the first time on the mesh network, and to update a bounce counter or time-to-live (TTL) of a message they receive before redistributing it, or to discard the message without redistributing it if the counter or time-to-live becomes zero.

It may also be possible to program processors 21 and 41 so that they can only redistribute a message to a limited group of nodes to which they are connected, or only redistribute messages that they have never distributed before.

Alternatively, the processors 21 and 41 can be programmed to transmit data by routing. In this configuration, routes between each source node and each destination node of the mesh network are predefined and stored in memories of devices 2 and 4, and each of the nodes is able to redistribute a message it receives and which is intended for a given destination node, only to the node of the route to this destination node that is stored in its memory.

In addition, the processors 21 and 41 can be programmed so that messages to be sent over the network are encrypted in advance, for example using an asymmetric encryption algorithm. If required, the processors 21 and 41 can generate a public-private key pair using measurements acquired by one of the sensors 43a to 43e, in particular from positioning data.

Finally, it should be noted that each of the processors 21 and 41 is arranged to periodically change the central transmission and listening frequency of the communications modules 22 and 42 by selecting the next frequency from a list of given frequencies. For example, a timer can be triggered by the processor 21, 41 after each frequency change, and the next frequency is selected when the timer expires. It should be noted that the said central transmission and listening frequencies are advantageously frequencies provided outside the frequency bands allocated to telecommunication operators for the deployment of their communication networks, and in particular their mobile telephony networks.

In connection with FIG. 2, we will now describe a method for assisting a user in moving, implemented by one of the systems 3 shown in FIG. 1.

Prior to moving, the team leader has defined, via the touch screen 21, a trail P between a start position PS and an end position PE, each defined by geographical coordinates. For example, the trail can be traced by the team leader on a map displayed on their touchscreen 21, and may comprise, inter alia, multiple waypoints along its route. This trail P is saved as a file in a given format, such as GPX.

The trail P is then transmitted, via communication module 22, over the mesh network to all of the systems 3.

Upon receiving the trail P, via its communication module 42, the processor 41 of the communication device 4 fragments the trail P into a plurality of waypoints WPᵢ.

More precisely, the processor 41 scans all the points on trail P and, for two consecutive points, determines the distance between the two points and the angle between the two points with respect to a reference direction. If the distance and angle are greater than given threshold values, the processor 41 registers these points as waypoints WPᵢ, and repeats for the next two consecutive points on trail P. Otherwise, the processor retains the first point and repeats for this point and the next consecutive point at the second point. In other words, the processor 41 selects those points on the trail P that result in significant changes in the user's orientation.

Subsequently, the processor 41 sequentially determines instructions for controlling the vibrating members 52 as a function of an estimated user position PU, by means of measurements made by one or more of the sensors 43a to 43e, with respect to these waypoints WPᵢ.

It should be noted that a plurality of instructions have been stored in advance in a memory of the communication device 4, each being associated with a movement notification, indicating to the user through the vibrating members a change of orientation or a movement, or a navigation notification, alerting the user through the members of an event to come or occurring during their movement.

For example, the following instructions could be considered:
a. For a “forward” movement notification: A simultaneous vibration of the two front members 52;
b. For a “90° left turn” movement notification: A vibration of the left lateral member 52, and for a “90° right turn” movement notification: A vibration of the right lateral member 52;
c. For a “45° left turn” movement notification: A simultaneous vibration of the left lateral member 52 and the left front member 52, and for “45° right turn” movement notification: A simultaneous vibration of the right lateral member 52 and the right front member 52;
d. For a “backward” movement notification: A vibration of the rear member 52;
e. For a “stop” movement notification: A simultaneous vibration of all members 52;
f. For an “alert before changing course” navigation notification: A sequence of two short, simultaneous vibrations of all members 52;
g. For an “off course” navigation notification: A sequence of four short, simultaneous vibrations of all members 52;
h. For an “end position” navigation notification: A sequence of two long, simultaneous vibrations of all members 52.

It should be noted that the instructions and notifications listed below are given by way of illustration, and that a different number of instructions and notifications, or other types of instructions and notifications, may be provided without departing from the scope of the present invention.

In this way, the processor 41 periodically estimates the user's position PU and the distance and/or direction between that position PU and the next waypoint WPᵢ, that is, the waypoint WPᵢ closest to this position PU and located downward from this position PU on trail P. The processor 41 can also estimate the distance between position PU and the trajectory between the last waypoint WPᵢ₋₁, that is, the waypoint WPᵢ₋₁ closest to this position PU and located upward from this position PU on trail P, and the next waypoint WPᵢ. By analyzing the evolution of this distance, in particular its growth, the processor 41 can estimate whether the user is drifting off the trail P.

The processor 41 can then select a movement instruction based on these distances.

For example, for the list of instructions given above, if:
a. the distance between position PU and the next waypoint WPᵢ is less than a first threshold value, the processor 41 can select the instruction associated with the “alert before course change” navigation notification;
b. the distance between position PU and the next waypoint WPᵢ is less than a second threshold value shorter than the first threshold value, the processor 41 can select the instruction associated with notification of movement in the direction of that next waypoint;
c. the distance between the position PU and the path between the last waypoint WPᵢ₋₁ and the next waypoint WPᵢ is greater than a third threshold value, the processor 41 can select the instruction associated with the “off course” navigation notification.

Each instruction selected by the processor 41 is then transmitted, via the connection means, to the control unit 53 of the portable device 5, which can then control the vibrating members 52 to generate the corresponding vibrations and thus guide the user moving along the trail P.

It should be noted once again that these examples have been given by way of illustration, and that the conditions under which an instruction is selected by the processor 41 may be more numerous or more complex, without departing from the scope of the present invention.

In addition, the processor 41 can periodically estimate the user's speed of movement and adapt the threshold values to which said distances are compared as a function of this speed of movement.

It should also be noted that the angles of the movement notifications linked to turns are associated with threshold values used by the fragmentation algorithm of the trail P, and that these threshold values can be adapted according to the turn angles usually used by the user.

Finally, it should be noted that the team leader has the ability to modify the trail P at any time, via the touch screen T, or to give a direct instruction to all or some of the users, such as an order to stop or retreat to a given position, which will be transmitted to their communication devices 4, via the mesh network, and then applied via the portable devices 5. In addition, separate trails can be transmitted to different users by the team leader.

For the purposes of estimating the user's position PU by the processor 41, this position PU can, for example, be obtained by means of the satellite positioning system receiver 43a.

In the event of failure of this receiver 43a, or following an interruption in satellite coverage, the processor 41 can continuously estimate the user's position PU from their last known position PU, that is, the last position obtained using the receiver 43a.

The data measured by the inertial unit 43c, barometer 43b and compass 43d enable the processor 41 to estimate, respectively, the number of strides covered during a user's movement, the user's speed of movement, a change in altitude during this movement, and the direction of this movement. It is therefore possible for processor 41 to estimate the distance traveled by the user and the direction taken by the user since their last known position, and thus to determine the user's current position PU.

Note that once the satellite positioning service is operational and accessible again, the PU position can then be corrected by processor 41 using the position received by receiver 43a.

This position PU, whether obtained using receiver 43a or estimated using sensors 43c, 43b and 43d, is transmitted by communication module 42 over the mesh network to the central device 2.

In connection with FIG. 3, we will now describe the more advanced features of the tactical information system 1.

All users' positions PUⱼ can be displayed and updated, as they are received via the mesh network, on a map displayed on touchscreen 23, so that the team leader can supervise users' movements.

When a movement is planned, the absence of movement by one of the users, for a period exceeding a given threshold value, can lead to the generation of an alert by the processor 21, which can be displayed on the touch screen 23.

Likewise, as described above, the team leader can give a direct instruction to one or more, or even all, of the users via the touch screen 23, which will be retransmitted to the communication device(s) 4 of that or those user(s) and then translated into an instruction via their portable device(s) 5. For example, the team leader could himself observe that one of the users has gone off course, such as the user marked by their position PU₄, and send them an “off course” notification followed by a movement notification indicating a corrected course.

The team leader can define in advance the perimeter of a zone Z, which may for example be a high-risk zone, and the processor 21 of the central device can evaluate the proximity of the PU positions of the users to this zone Z and transmit, if necessary, an instruction to the communication device(s) 4 of the users who are too close, such as the user marked by their position PU₅, to halt or change their course. This instruction can also be transmitted manually by the team leader.

In addition, the processor 41 of each communication device 4 may be arranged to identify whether a sound detected by the sound sensor 43e is the sound of a gunshot, for example by comparing the intensity of this sound with a given threshold and/or by comparing the sound spectrum of this sound with a spectrum model of a gunshot sound. If required, the processor 41 can be arranged to estimate the direction in which the sound is received, and said estimated direction is transmitted to the central device 2 via the mesh network.

As shown in FIG. 4, it is understood that if at least three communication devices 4 detect such a sound from a firearm, such as those of users marked by positions PU₃, PU₄, and PU₅, and these communication devices 4 are not aligned, then the processor 21 has three different estimates of the direction of sound reception, each correlated to the position PU of one of these communication devices 4. Processor 21 can thus triangulate the position of origin PO of the shot from these directions of reception and these positions, and the team leader can define a strategy and alert the users accordingly via the mesh network.

Finally, in an example not shown, each user may be equipped with a firearm fitted with a device for detecting a shot fired from that firearm, which may be connected, by wireless connection means such as a Bluetooth transceiver, to the user's communication device 4. The processor 41 can thus count the number of shots fired by the user and relay this number, via the mesh network, to the central device 2, so that the team leader can monitor the quantity of ammunition remaining for each user and organize a reload accordingly.

In connection with [FIG. 5] to [FIG. 7], an example of a communication device 100 according to the invention will now be described.

In a similar way to the communication devices 4 shown in [FIG. 1], the communication device 100 comprises a casing 101 wherein are arranged a processor, wireless connection means, a wireless communication module fitted with an antenna, a satellite positioning system receiver, a barometer, a 9-axis inertial unit, and a sound sensor, all these components not being illustrated but referred to in [FIG. 5 ] by a common reference 102.

The communication device 100 comprises a battery, comprising multiple lithium-titanate lithium-ion type accumulators, associated with an electrical conversion device for supplying electrical power to the various electronic components mentioned above. This battery and conversion device are not shown either, but referenced in [FIG. 5] under a common reference 103.

The casing 101 comprises two parts, namely a lower part 101a wherein the battery and the conversion device 103 are arranged, and an upper part 101b wherein the components 102 are arranged. A battery charge status indicator 104 is provided on a wall of the lower part 101a.

As shown in [FIG. 6], an electrical connector 105 is arranged in the upper part 101b, a portion of the connector 105 passing through an opening in a bottom wall of this upper part 101b. When the parts 101a and 101b are assembled, this part of the connector 104 therefore extends into the lower part 101a.

Each of the lower and upper parts 101a and 101b is fitted with fasteners 106 for joining these parts together. When the lower part 101a is mounted on the upper part 101b, these fasteners 106 cooperate with each other and the electrical connector 105 cooperates with an electrical connector of the conversion device 103. As soon as this connection between the connector 104 and the conversion device 103 is made, the battery 103 automatically discharges in order to supply power to the electronic components 102.

It should be noted that the casing 101 is made of an anodized aluminum-magnesium alloy, e.g. EN-AW 5083, and has an ingress protection rating, as defined in EN 60529, of IP68 and/or an impact protection rating, as defined in EN 62262, of IK6. This ensures that the casing is hardened and offers particularly high impact resistance, which is desirable given the conditions under which the device 100 may be used. It should also be noted that the upper part 101b has grooves 101c on some of these walls to dissipate the heat emitted by the various electronic components 102.

With the exception of a single button 107, the communication device 100 has no interface enabling the user to enter and/or view data, such as a touch screen, which would be too fragile and present too many interaction difficulties given the conditions of use envisaged.

The button 107 is of the push-button type. It is arranged on a front wall of the upper part 101b, extending through an opening 107a in this wall. This button features a silicone layer (not shown) to seal this opening. It is funnel-shaped and tapers towards the inside of the casing, centered on an electronic switching element (not shown) arranged in the casing. Pressing this button thus enables the device 100 to be activated or deactivated via this switching element, and in the event of repeated pressing, to control the transmission of an alert by the communication module on the mesh network. The upper part 101b has holes 107b, visible in FIG. 6, evenly distributed around the circumference of the opening 107a, so that pins (not shown) distributed around the circumference of the button 107 can be inserted into these holes 107b. The size of the button makes it easier for the user to press it, even when visibility is poor, and the counters prevent any movement of the button except towards the switching element, a direction favored by the funnel shape of the button.

In the example described, the satellite positioning system receiver, barometer, 9-axis inertial unit, and sound sensor are arranged on a single printed circuit board 108, visible in [FIG. 6] and [FIG. 7], which faces a side wall of the upper part 101b

As shown in [FIG. 7], a cover 109 made of a plastic polymer covers the board 108 and is interposed between this board 108 and the side wall of the upper part 101b. This cover 109 has a window 109a opposite the barometer, 9-axis inertial unit, and sound sensor, which are grouped together in the same area of the board 108. The cover 109 further comprises a recess 109b, projecting from the rest of the cover, arranged opposite the satellite positioning system receiver. If required, the side wall of the upper part 101b comprises a window from which the recess 109b of the cover projects. The cover 109 thereby protects the various sensors, seals the casing 101, and enables the receiver to receive positioning data. A plating part 110 is screwed to the upper part 10b and presses the board 108 against the side wall of the upper part 101b. This ensures that the board 108 and the components it supports are held statically in the casing 101.

Note that the other electronic components 102, that is, the processor, communication module, and connection means, are mounted on a stack of printed circuit boards (not shown) arranged in the upper part 101b, extending perpendicularly to the board 108.

The upper part 101b has a ring 111 mounted at an opening in a top wall of the upper part 101b. The communication module antenna thus extends through said opening and ring 111.

As shown in [FIG. 5], the casing 101 comprises a protective cap 112 for the antenna, a lower part of this cap 112 being inserted into the ring 111. The cap 112 has a side hole 112a and a distal hole 112b. The side hole allows a wire antenna to pass through, while the distal hole allows a tube antenna to pass through, thus leaving the choice of antenna type for the communication module open.

The ring 111 has a plurality of positioning holes 111a evenly distributed around its circumference and the cap has one or more positioning pins 112c evenly distributed around its circumference, each positioning pin 111b fitting into one of the positioning holes 111a, so that the cap 112 is held on the ring and it is possible to choose the direction wherein the side hole 112a is oriented.

It should be noted that, in the various use cases presented above, all the functionalities of the tactical information system remain operational, whatever the state of network coverage in the area covered by the users, thanks to the use of communication modules which together form a mesh network. This ensures that the team can move synchronously and autonomously, whatever the conditions of the operation, while the team leader retains advanced monitoring capabilities. In addition, all these functionalities are integrated into a single communication device, which avoids the need for multiple devices that would impair user concentration and efficiency. It should also be noted that the various features of the communication device, and in particular its casing, guarantee a long service life for this communication device and prevent deterioration of the various components it contains, due to shocks, vibrations, or infiltration of water, moisture, or sand. This ensures that the communication device can function under all operating conditions.

The preceding description thus clearly explains how the invention achieves its stated objectives.

In any case, the invention is not limited to the embodiments specifically described in this document, and extends in particular to any equivalent means and to any technically operative combination of these means. In particular, it may be possible to replace the vibrating members with other tactile stimulation members, such as electrodes. It is also possible to add sensors other than those mentioned above, or to replace some of these sensors with other types of sensors to obtain information on a user's position or movement. Other types of wearable device than a sleeve could also be envisaged, such as a glove or wristband instead, or each user could be equipped with a plurality of wearable devices.

1. A tactical portable communication system for a user, comprising:
a communication device provided with a casing that has arranged in it a processor, a communication module for communication with a wireless mesh network, and a plurality of user position and/or motion sensors, and
a portable device able to be attached to a limb of a user and equipped with tactile stimulation members for the tactile stimulation of said limb and with a control unit able to command and control each of the tactile stimulation members,
wherein the communication device and the portable device each comprise associated wireless connection means, and in that the processor of the communication device is designed:
on the basis of data received, by the communication module, from the mesh network and/or of measurements acquired by one or more of said sensors, to transmit, via the connection means, an instruction to the control unit of the portable device to control the tactile stimulation members;
on the basis of data received, by the communication module, from the mesh network and/or of measurements acquired by one or more of said sensors, to transmit, via the communication module, a sequence of data on the mesh network.

2. The portable system according to claim 1, wherein upon receipt of a data sequence from the mesh network by the communication module, the communication module is able to retransmit the received data sequence onto the mesh network.

3. The portable system according to claim 1, wherein the processor is arranged to estimate a movement of the user, from measurements acquired by one or more of said sensors, since their last known position and to estimate a new position of the user from said estimated movement and said last known position.

4. The portable system according to claim 1, wherein the communication device is arranged to receive, from the mesh network, a sequence of data defining a trail between a start position and an end position, and in that the processor is arranged to determine, from said sequence of data, a set of waypoints fragmenting said trail and to transmit, via the connection means, an instruction to the control unit of the portable device for controlling the tactile stimulation members, said instruction being determined as a function of a user position estimated from measurements acquired by one or more of said sensors and said set of waypoints.

5. The portable system according to claim 4, wherein the communication device comprises a memory wherein are stored a plurality of predetermined instructions for controlling the tactile stimulation members, in that the processor is arranged to select at least one of said predetermined instructions stored in said memory as a function of said user's estimated position with respect to at least one of the waypoints and to transmit, via the connection means, said selected instruction to the control unit of the portable device, and in that the control unit is arranged, in response to receiving said instruction, to control the tactile stimulation members to generate said selected instruction.

6. The portable system according to claim 1, wherein the communication device comprises at least one sound sensor and the processor is arranged to determine whether a sound detected by said sound sensor is a gunshot sound, to estimate a direction of reception of said detected sound and to transmit, via the communication module, a data sequence containing said estimated direction of reception over the mesh network.

7. The portable system according to claim 1, further comprises a device for detecting a shot fired by the user, the detection device comprising wireless connection means associated with the wireless connection means of the communication device, and in that the detection device and/or the processor of the communication device is arranged to estimate a number of shots fired by the user over a period of time, from measurements acquired by the detection device, and in that the processor is arranged to transmit, via the communication module, a data sequence containing said estimated number over the mesh network.

8. The portable system according to claim 1, wherein the communication module is adapted to transmit a data sequence over the mesh network by modulating, using said data sequence, a carrier wave having a center frequency selected from a plurality of predetermined center frequencies, and in that the processor is arranged to periodically select a new center frequency from said plurality of predetermined center frequencies for said transmission.

9. A tactical information system, comprising a plurality of portable systems according to claim 1, and a central control device comprising a processor, a visualization and interaction interface and a communication module with a wireless mesh network, the communication devices of all the portable systems and the central device forming a wireless mesh network, each communication device being able to exchange data, via its communication module and through the wireless mesh network, with the central device.

10. The tactical information system according to claim 9, wherein the central control device is arranged to, depending on a user's interaction with the visualization and interaction interface, transmit to the communication device of at least one of the portable systems, via its communication module and through the wireless mesh network, a data sequence defining a trail between a start position and an end position.

11. The tactical information system according to claim 9, wherein the central device is able to receive, from the communication device of at least one of the portable systems, a data sequence containing a position of the user of this portable system, and wherein the processor of the central device is arranged, upon receipt of said data sequence, to update a map displayed on the visualization and interaction interface using said user position.

12. The tactical information system according to claim 9, wherein the central device is able to receive, from the communication device of at least one of the portable systems, a data sequence containing a position of the user of this portable system, and wherein the processor of the central device is arranged, upon receipt of said data sequence, to compare said position of the user with respect to a predetermined geographical area and, as a function of said comparison, to transmit, via the communication module and through the wireless mesh network, a data sequence containing an alert.

13. The tactical information system according to claim 9, wherein the central device is adapted to receive, from the communication device of at least three of the portable systems, data sequences each containing a direction of reception of a same sound of a detected gunshot, and wherein the processor of the central device is arranged, upon reception of said data sequences, to determine a position of origin of said shot.

14. A communication device for a tactical portable communication system according to claim 1.

15. The communication device according to the preceding claim 14 further comprises at least one sensor or a combination of sensors chosen from: an accelerometer, a gyroscope, an inertial unit, a compass, a satellite positioning system receiver, a barometer, an altimeter, a pedometer.

16. The communication device according to claim 14, further comprises a battery, in that the casing may comprise two parts, in that the battery is arranged in one of the parts while the processor, the communication module, and said plurality of sensors are arranged in the other of the parts, and in that the casing is made of an aluminum-based material.

17. The communication device according to claim 14, further comprises at least one motion sensor and at least one receiver of a satellite positioning system, said motion sensor and receiver being arranged on the same printed circuit board, in that it comprises a cover made of a plastic polymer and interposed between the said printed circuit board and the casing, the cover comprising a window arranged opposite the said motion sensor and a recess arranged opposite the receiver, and in that the casing comprises a window arranged in a wall opposite which the cover is provided, the recess of the cover projecting from the window.
